(19) United States
(12) Patent Application Publication
(10) Pub. No.: US 2009/0093181 A1
(43) Pub. Date: Apr. 9, 2009

(54) CARBON NANOTUBE FIELD EMISSION DEVICE AND METHOD OF MANUFACTURING THE SAME

(76) Inventors: Yong-Wan Jin, Seoul (KR); Chang-Ho Noh, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 11/145,982

(22) Filed: Jun. 7, 2005

(30) Foreign Application Priority Data
Jun. 8, 2004 (KR) 10-2004-0041853

(51) Int. Cl. H01J 9/00

(52) U.S. Cl. 445/58

(57) ABSTRACT

A method of manufacturing a carbon nanotube field emission device whereby a catalyst layer is formed on a base structure, a solution containing a carbon nanotube powder is coated on the catalyst layer, and an electroless deposition solution is coated on the carbon nanotube coating layer. The method can provide a carbon nanotube field emission device having an improved field emission efficiency and increased lifetime.

### CLAIM OF PRIORITY

This application claims the benefit of Korean Patent Application No. 10-2004-0041853, filed on Jun. 8, 2004, in the Korean Intellectual Property Office, the disclosure of which is incorporated herein in its entirety by reference.

### BACKGROUND OF THE INVENTION

1. Field of the Invention

The present invention relates to a carbon nanotube field emission device and a method of manufacturing the same, and more specifically, to a carbon nanotube field emission device having improved field emission and a method of manufacturing the same.

2. Description of the Related Art

A carbon nanotube is a carbon allotrope having a hexagonal cross-section and a high aspect ratio. Carbon nanotubes have diameter on the order of nanometers. Further, carbon nanotubes are chemically stable and have metallic or semiconductive properties. Thus, carbon nanotubes are attracting interest as a new material for field emitters, hydrogen storage mediums, polymer reinforcing agents, etc.

Recently, carbon nanotubes have been widely used as field emitters in backlights for liquid crystal displays (LCDs), field emission displays (FEDs), etc. In FEDs, a voltage is applied between an anode and a cathode to generate an electric field, and electrons are emitted from the cathode to collide with fluorescent materials, thus producing light.

In conventional FEDs, microtips comprised of metal, such as molybdenum etc., were used as field emitters. However, these metal emitters have a high work function, and thus a high driving voltage, and have a short lifetime owing to the effects of atmospheric gas or an inconsistent electric field. To overcome these disadvantages, vigorous research on carbon nanotubes has been conducted.

As described above, carbon nanotubes have a high aspect ratio. When carbon nanotubes are used as field emitters, they must be vertically aligned on a base structure to improve discharge current density and to increase their lifetime. Thus, the manufacturing process can significantly affect the performance of FEDs.

In a conventional method for growing carbon nanotubes, a carbon-containing material, such as a carbon nanotube, is mixed with a solution of organic or inorganic material to obtain a paste. Then, the paste is printed on a base structure, such as a substrate, and exposed to light. However, it is difficult to obtain a paste containing 10% or more carbon nanotubes, and there is a problem of deterioration of the carbon nanotubes, since a high temperature process (about 400° C. or higher) is required when removing the organic material. Further, surfaces of the carbon nanotubes must be post-treated in a separate process. Unless the post-treatment is performed, alignment of the carbon nanotubes is very poor, resulting in non-uniform electric field emission. Moreover, when an insulating layer or a gate metal layer is thick, it is difficult to inject the paste inside a very small hole and to perform a surface-treatment of the carbon nanotubes.

Carbon nanotubes can also be grown directly on a base structure, such as a substrate, using chemical vapor deposition (CVD). Although this method is useful to grow carbon nanotubes vertically, the reaction temperature must be at least about 500° C., and thus there is a problem of deterioration of the carbon nanotubes, as described above, and it is difficult to grow the carbon nanotubes on a substrate that is unstable in heat, such as glass. Further, the formation of carbon nanotubes in a large area requires expensive equipment, resulting in high costs.

### SUMMARY OF THE INVENTION

It is therefore an object of the present invention to provide an improved field emission device.

It is also an object of the present invention to provide a method for manufacturing the improved filed emission device.

The present invention provides a field emission device which does not require a separate process for vertically aligning carbon nanotubes to activate the carbon nanotubes and in which the carbon nanotubes cover a large area.

According to an aspect of the present invention, there is provided a method of manufacturing a carbon nanotube field emission device comprising: forming a catalyst layer on a base structure; coating a solution containing a carbon nanotube powder on the catalyst layer; and coating an electroless deposition solution on the carbon nanotube coating layer.

The base structure may comprise a substrate and a first electrode formed on the substrate.

The catalyst layer may be composed of a material containing a photocatalytic compound.

The photocatalytic compound may contain TiO₂ and PVA.

The method may further comprise exposing the catalyst layer to UV light to activate the photocatalytic compound, after the forming the catalyst layer on the base structure.

The catalyst layer may be composed of a material containing an electroless deposition catalyst.

The electroless deposition catalyst may comprise at least one selected from the group consisting of SnCl₂ and PdCl₂.

The carbon nanotube coating layer may be formed by coating an aqueous solution containing H₂O and carbon nanotube powder on the catalyst layer.

The electroless deposition solution may contain metal ions including nickel ions.

According to another aspect of the present invention, there is provided a method of manufacturing a triode carbon nanotube field emission device, the triode carbon nanotube field emission device comprising a substrate, a first electrode formed on the substrate, an insulating layer exposing the first electrode and formed on the substrate, and a gate electrode formed on the insulating layer, the method comprising: forming a catalyst layer containing a photocatalytic compound on the first electrode and exposing the catalyst layer to UV light to activate the photocatalytic compound; coating an aqueous solution containing a carbon nanotube powder on the catalyst layer; and coating an electroless deposition solution on the carbon nanotube coating layer.

According to still another aspect of the present invention, there is provided a method of manufacturing a triode carbon nanotube field emission device, the triode carbon nanotube field emission device comprising a substrate, a first electrode formed on the substrate, an insulating layer exposing the first electrode and formed on the substrate, and a gate electrode formed on the insulating layer, the method comprising: coating a photoresist on the first electrode and the gate electrode and exposing the photoresist on the first electrode to UV light to remove the exposed photoresist; forming a catalyst layer containing an electroless deposition catalyst on the first electrode and coating an aqueous solution containing a carbon nanotube powder on the catalyst layer; and coating an electroless deposition solution on the carbon nanotube coating layer and removing the photoresist on the gate electrode.

According to yet another aspect of the present invention, there is provided a carbon nanotube field emission device comprising: a base structure comprising a first electrode; a plurality of carbon nanotubes vertically arranged on the first electrode; and metal materials grown between the carbon nanotubes.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, in which::

FIG. 1 is a flow chart illustrating a method of manufacturing a carbon nanotube field emission device according to an embodiment of the present invention;

FIGS. 2A through 2E are cross-sectional views illustrating the process of manufacturing a carbon nanotube field emission device illustrated in FIG. 1;

FIGS. 3A through 3C are views illustrating a process of forming a photocatalyst in the process illustrated in FIG. 2B;

FIGS. 4A and 4B are cross-sectional views illustrating vertical alignment of carbon nanotubes in the process illustrated in FIG. 2D;

FIGS. 5A through 5D are cross-sectional views illustrating a method of manufacturing a triode carbon nanotube field emission device using a photocatalyst according to an embodiment of the present invention; and

FIGS. 6A through 6D are cross-sectional views illustrating a method of manufacturing a triode carbon nanotube field emission device using an electroless deposition catalyst according to still another embodiment of the present invention.

### DETAILED DESCRIPTION OF THE INVENTION

Hereinafter, a method of a carbon nanotube field emission device according to embodiments of the present invention will be described in detail with reference to the attached drawings.

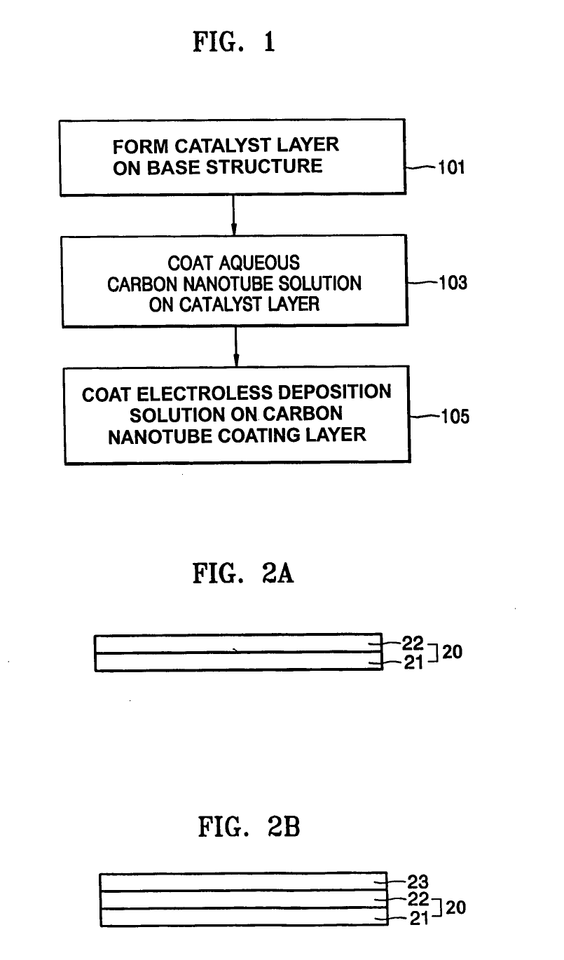

FIG. 1 is a flow chart illustrating a method of manufacturing a carbon nanotube field emission device according to an embodiment of the present invention. Referring to FIG. 1, the method of manufacturing a carbon nanotube field emission device comprises forming a catalyst layer on a base structure (101), coating an aqueous solution containing carbon nanotubes on the catalyst layer (103), and coating an electroless deposition solution on the carbon nanotube coating layer (105).

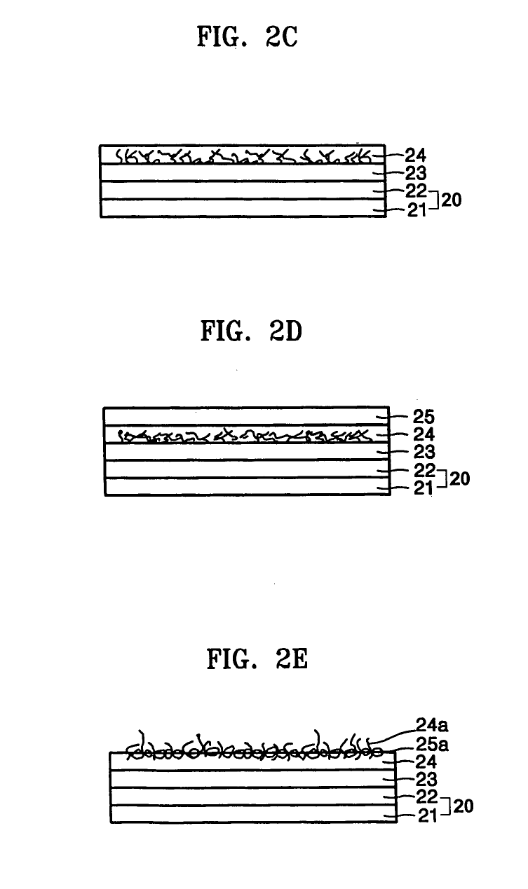

FIGS. 2A through 2E are cross-sectional views illustrating the process of manufacturing a carbon nanotube field emission device illustrated in FIG. 1.

Referring to FIG. 2A, first, a base structure 20 is provided. The carbon nanotubes will be formed on the base structure 20. The base structure 20 can be appropriately selected depending on the application of the carbon nanotubes, and in FIG. 2A, the base structure 20 comprises a substrate 21 and a first electrode 22 formed on the substrate 21. The substrate 21 may be any substrate conventionally used in a semiconductor process. The first electrode 22 is composed of a conductive material, and may include a metal electrode and a metal oxide electrode, for example, an indium tin oxide (ITO) electrode, which is a transparent electrode.

Referring FIG. 2B, a catalyst layer 23 is formed on the first electrode 22. The catalyst layer 23 is preferably composed of one of two materials (i.e., a photocatalytic compound and an electroless deposition catalyst).

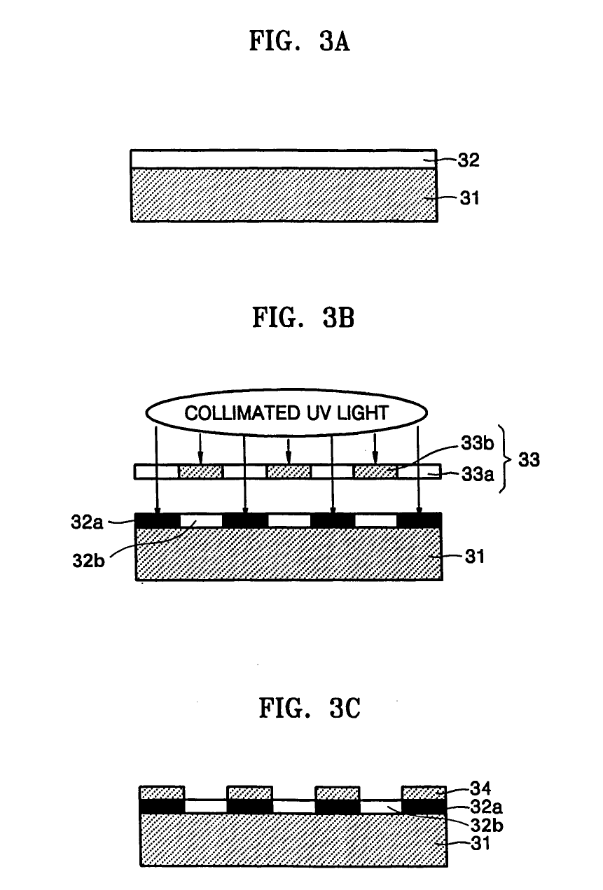

The first material is the photocatalytic compound described in Russian Patent No. 636,579 (published on Dec. 5, 1978), which is incorporated herein by reference. The photocatalytic compound comprises TiO₂ and a water-soluble polymer, such as polyvinyl alcohol (PVA). The formation principle of such a photocatalytic compound are illustrated in FIGS. 3A through 3C.

As illustrated in FIG. 3A, a photocatalytic compound comprising Ti is coated on a substrate 31, for example, a glass, silicon, or plastic substrate to obtain a catalyst layer 32. Then, as illustrated in FIG. 3B, a mask 33 is disposed above the catalyst layer 32 and the catalyst layer 32 is exposed to UV light. The mask 33 has a UV-transmitting region 33a and a UV-blocking region 33b. The catalyst layer 32 can be exposed to the UV light only through the UV-transmitting region 33a. In an exposed region corresponding to the UV-transmitting region 33a, the photocatalytic compound is activated by the UV light to form an activated region 32a. The term “activated” means Ti in a photocatalytic compound is separated into a proton and electrons.

Then, an electroless deposition solution containing metal ions or metal compound ions, such as Ni, Pd, Sn, or Zr, is coated on the catalyst layer 32. The metal ions or metal compound ions coated on the activated region 32a of the catalyst layer 32 are reduced by electrons from the activated region 32a. Thus, the reduced metal ions or metal compound ions can grow on the activated region 32a to form a metal layer 34. A region of the catalyst layer 32b corresponding to the UV-blocking region 33b is not activated, and thus cannot grow a metal. As a result, it is possible to selectively grow the metal.

In an embodiment of the present invention, carbon nanotubes can be grown vertically using the photocatalytic compound as described above.

The catalyst layer 23 may also be composed of an electroless deposition catalyst. The electroless deposition catalyst includes salts of tin, preferably SnCl₂, salts of palladium, preferably PdCl₂ and the like. Such an electroless deposition catalyst can reduce the metal ions or metal compound ions like the photocatalytic compound described above. The difference between the electroless deposition catalyst and the photocatalytic compound is that the photocatalytic compound can be activated by UV light, etc., and if the photocatalytic compound is not activated, it cannot reduce the metal ions or metal compound ions, whereas the electroless deposition catalyst can be activated by acidic ammonium fluoride and reduce the metal ions or metal compound ions.

Referring back to FIG. 2B, the photocatalytic compound or the electroless deposition catalyst is coated on the first electrode 22 to form the catalyst layer 23. When the photocatalytic compound is coated on the first electrode 22, UV light is irradiated on the catalytic layer 23. As described above, this exposure is performed to activate the photocatalytic compound, and when the base structure 20 including the substrate 21 and the first electrode 22 has high light transmittance, UV light can be irradiated from a back of the substrate 21 to activate the photocatalytic compound.

Then, as illustrated in FIG. 2C, a solution containing carbon nanotubes is coated on the catalyst layer 23 to form a carbon nanotube coating layer 24. The solution containing carbon nanotubes can be prepared by dispersing a carbon nanotube powder in an organic or inorganic solution, etc. An aqueous solution of carbon nanotubes can also be used. More carbon nanotubes can be contained in the aqueous solution than in a conventional carbon nanotube paste, which contains carbon nanotubes with a concentration of less than about 10%.

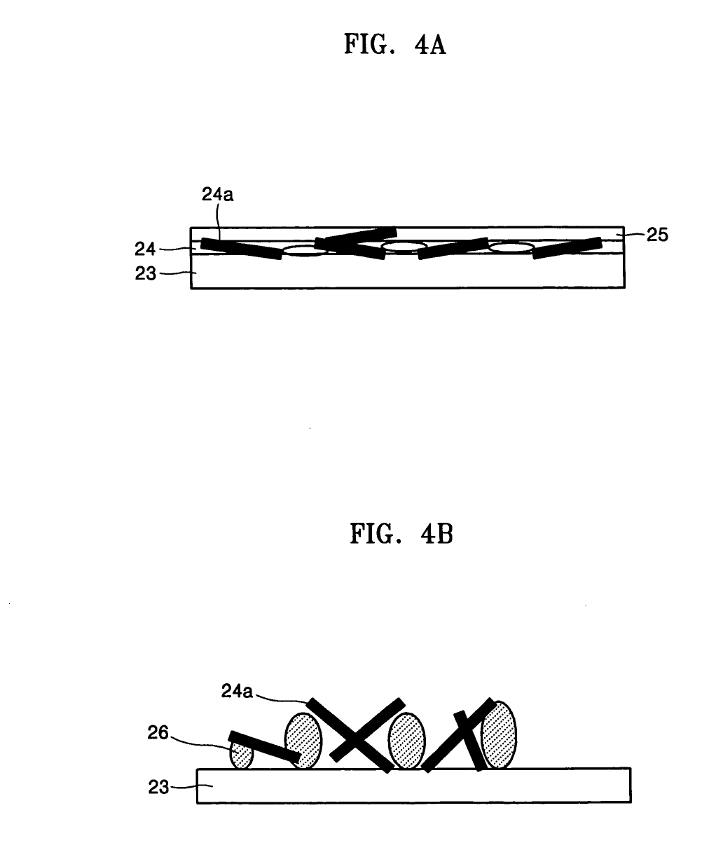

Next, as illustrated in FIG. 2D, an electroless metal deposition solution, for example, an electroless Ni deposition solution, is coated on the carbon nanotube coating layer 24 to form an electroless deposition layer 25. The activated photocatalyst or electroless deposition catalyst (SnCl₂ or PdCl₂) of the catalyst layer 23 reduces the metal ions of the electroless deposition layer 25 to induce growth of the metals and thus induce vertical growth of carbon nanotubes distributed in random directions in the carbon nanotube coating layer 24. The growth of the carbon nanotubes will now be explained with reference to FIGS. 4A and 4B.

Referring to FIG. 4A, the carbon nanotube coating layer 24 is formed on the catalyst layer 23. As described above, the carbon nanotube coating layer 24 can be formed using an aqueous solution containing a carbon nanotube powder, for example. In general, when a material containing carbon nanotubes 24a is coated on a base structure 20, the carbon nanotubes 24a are randomly disposed, as illustrated in FIG. 4a. When these randomly disposed carbon nanotubes 24a are used as field emitters in a field emission device, field emission efficiency is low and the performance and the lifetime of the field emission device are reduced. To overcome these problems, the carbon nanotubes 24a must be grown in a direction of field emission (generally perpendicular to a face of the base structure 20). Thus, a growth direction of the carbon nanotubes 24a must be controlled. The catalyst layer 23 and the electroless deposition layer 25 are intended to ensure the vertical growth of the carbon nanotubes 24a.

Referring to FIG. 4B, the metal 26 reduced by the photocatalyst, the Sn salt or the Pd salt is grown between the carbon nanotubes 24a, which are distributed in random directions on the catalyst layer 23. The metal 26 is contained in the electroless deposition layer 25. As the metal 26 grows, the carbon nanotubes 24a becomes aligned perpendicular to a face of the base structure 20.

Thus, as illustrated in FIG. 2E, when the electroless deposition solution is coated on the carbon nanotube coating layer 24, a metal 25a in the electroless deposition layer 25 grows while vertically aligning the surrounding carbon nanotubes 24a. Thus, a carbon nanotube field emission device according to an embodiment of the present invention can be obtained.

A method of manufacturing a simple type of a carbon nanotube field emission device has explained. This method can be conveniently applied to a field emission device having a triode structure. Hereinafter, a method of manufacturing a carbon nanotube field emission device having a triode structure will be described in detail with reference to the drawings.

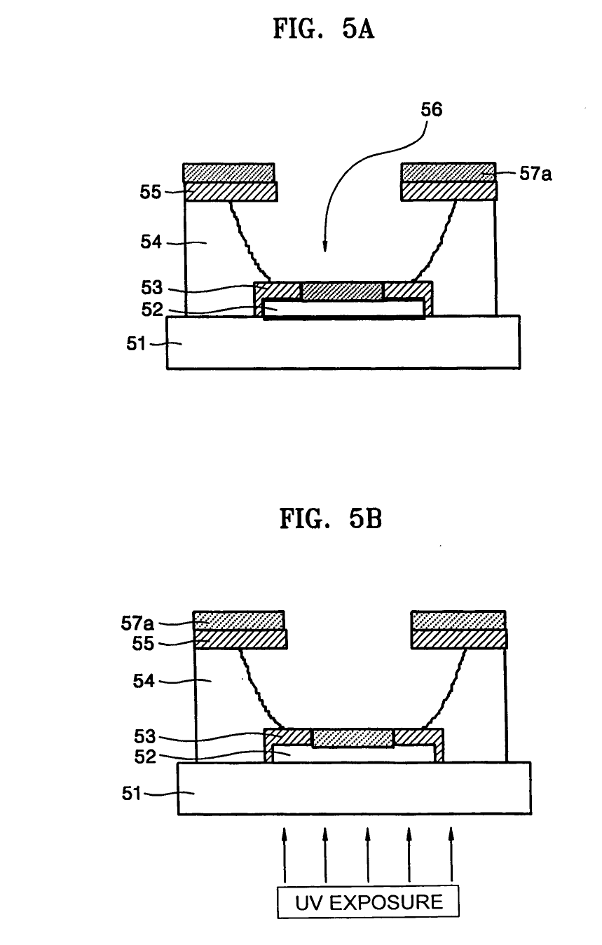

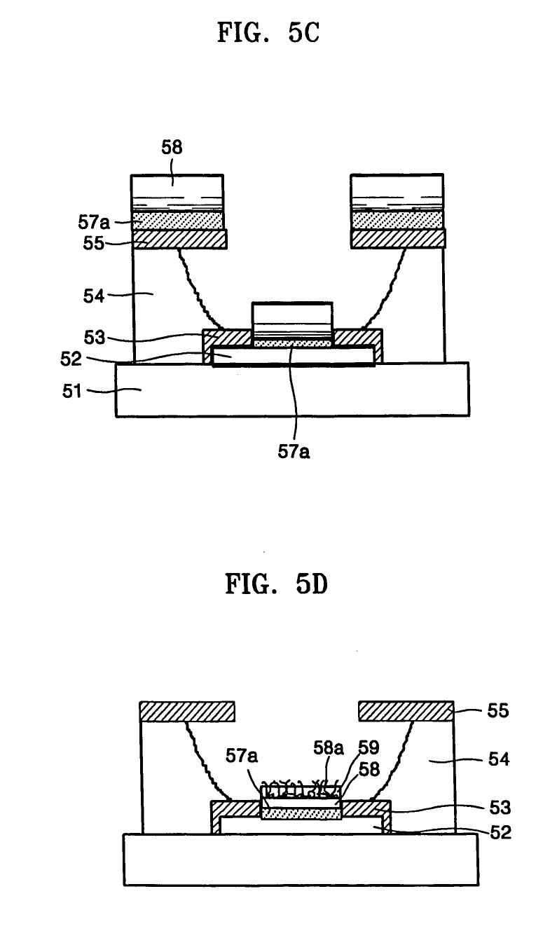

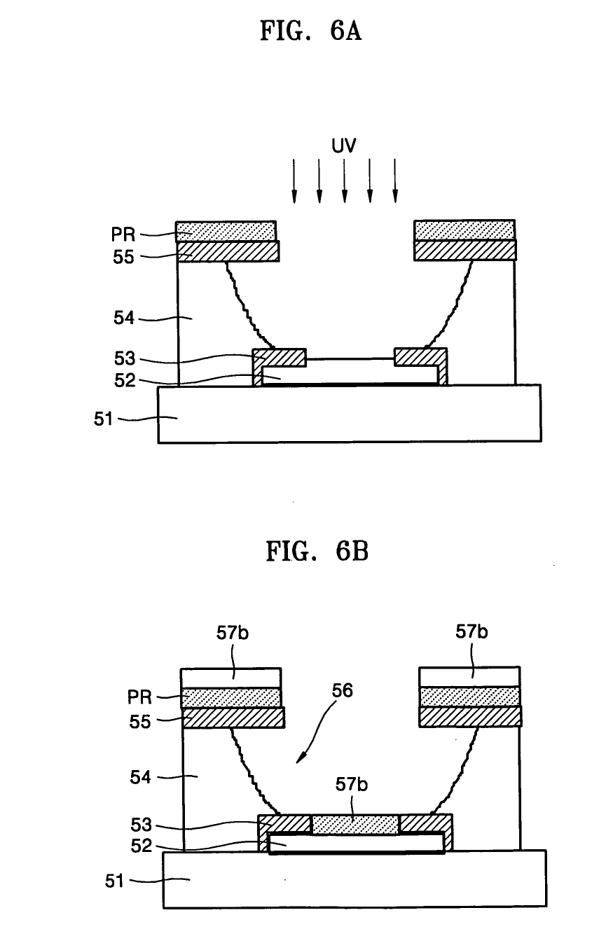

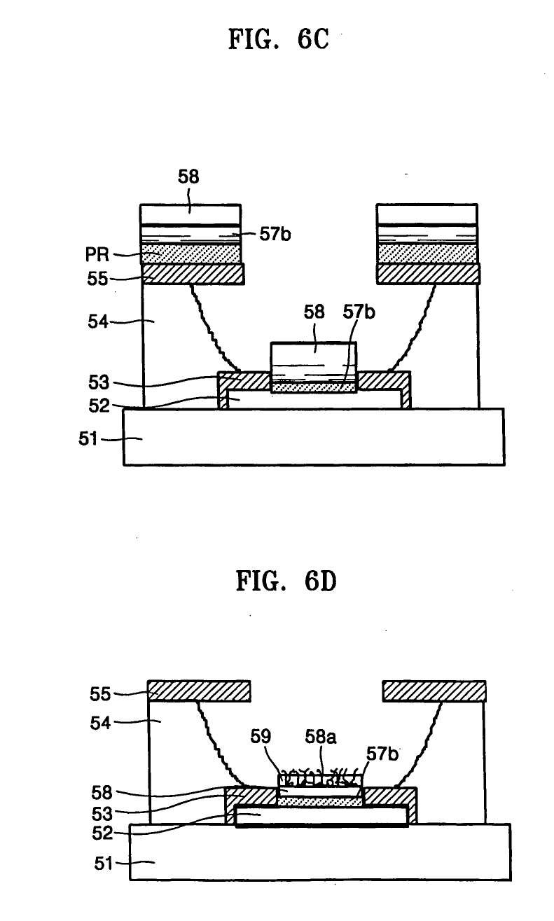

A basic triode structure can be easily constructed using a conventional method, which will be briefly described with reference to FIGS. 5A and 6A. A conductive material, such as metal or metal oxide, is coated on a substrate 51 and then both edges of the coating are removed to form a first electrode 52. Optionally, SiO₂ or the like is coated on the first electrode 52, and a location in which carbon nanotubes are to be grown is etched to form a barrier layer 53. Then, an insulating layer 54 and a gate electrode 55 are sequentially formed on the substrate 51 and the first electrode 52. Subsequently, patterning and etching are performed to expose a surface of the first electrode 52 and form a hole 56. In this way, a basic triode structure can be obtained.

FIGS. 5A through 5D are cross-sectional views illustrating a method of manufacturing a triode carbon nanotube field emission device using a photocatalyst according to an embodiment of the present invention.

First, referring to FIG. 5A, a photocatalyst layer 57a is coated on a basic triode structure. The photocatalyst layer 57a can be composed of the material described with reference to FIG. 2B. The photocatalyst layer 57a is formed on the first electrode 52 and the gate electrode 55. As illustrated in FIG. 5B, the photocatalyst layer 57a is exposed to UV light for activation. In the exposure, when the substrate 51 and the first electrode 52 are composed of materials having a high light transmittance, for example, glass and ITO, UV light can be irradiated from below the substrate 51, as illustrated in FIG. 5B.

Referring to FIG. 5C, carbon nanotubes are then dispersed in an organic or inorganic material or H₂O, and the carbon nanotube dispersion is coated on the photocatalyst layer 57a to obtain a carbon nanotube coating layer 58. The carbon nanotubes are preferably dispersed in water. The organic dispersion necessitates a separate process for removing the organic material (heat treatment) during a post-treatment.

Referring to FIG. 5D, an electroless deposition solution is coated on the carbon nanotube coating layer 58 to obtain an electroless deposition layer 59. Then, metal ions in the electroless deposition layer 59 are reduced by the photocatalyst to allow the metal to grow. Thus, the carbon nanotubes 58a, which are distributed in random directions, grow perpendicularly to the first electrode 52. Then, material formed on the gate electrode 55 is removed to obtain a triode carbon nanotube field emission device.

FIGS. 6A through 6D are cross-sectional views illustrating a method of manufacturing a triode carbon nanotube field emission device using an electroless deposition catalyst according to another embodiment of the present invention.

Referring to FIG. 6A, a photoresist PR is coated on a basic triode structure and a portion of the first electrode 52, in which carbon nanotubes are to be grown, is exposed to light to remove the photoresist PR thereon. Next, as illustrated in FIG. 6B, an electroless deposition catalyst layer 57b is coated on the basic triode structure. The electroless deposition catalyst layer 57b can be composed of the material described with reference to FIG. 2B, such as SnCl₂ or PdCl₂. The electroless deposition catalyst layer 57b is formed on the first electrode (e.g., cathode) 52 and on the photoresist PR formed on the gate electrode 55.

As illustrated in FIG. 6C, a carbon nanotube powder is then dispersed in H₂O or an organic or inorganic material, and the carbon nanotube dispersion is coated on the electroless deposition catalyst layer 57b to obtain a carbon nanotube coating layer 58. Then, as illustrated in FIG. 6D, an electroless deposition solution is coated on the carbon nanotube coating layer 58 to obtain an electroless deposition layer 59. Then, metal ions in the electroless deposition layer 59 are reduced by the catalyst SnCl₂ or PdCl₂ to allow the metal to grow. Thus, the carbon nanotubes 58a which are distributed in random directions, grow perpendicularly to the first electrode 52. Then, the photoresist PR formed on the gate electrode 55 can be easily lifted off to obtain a triode carbon nanotube field emission device.

The field emission device and the method of manufacturing the same according to the embodiments of the present invention have the following advantages.

First, if organic materials not used in the embodiments, it is not necessary to perform a separate process to eliminate the organic materials. According to the present invention, organic materials are not necessary. Thus, the carbon nanotubes are not deteriorated. Since there is no residual organic material, the carbon nanotube field emission device can have a longer lifetime.

Second, there is no need to perform a separate process for vertically aligning carbon nanotubes during manufacturing a field emission device.

Third, the catalyst layer can be selectively formed on a predetermined location by using a solution coating method.

Fourth, since the carbon nanotubes can be coated in the form of an aqueous solution, it is possible to selectively form field emitters in a predetermined region of a complicated triode structure.

While the present invention has been particularly shown and described with reference to exemplary embodiments thereof, these embodiments are for illustrative purpose, and are not intended to limit the scope of the present invention. That is, the method of manufacturing a carbon nanotube field emission device can be used in manufacturing field emitters for emitting electrons and can be applied to a field emission device manufactured using a common basic manufacturing principle regardless of the structure of the field emission device, for example, a diode or a triode. Thus, the scope of the present invention is defined by the following claims, not by the exemplary embodiments.

1. A method of manufacturing a carbon nanotube field emission device, comprising:
forming a catalyst layer on a base structure;
forming a carbon nanotube coating layer by coating a solution containing a powder of carbon nanotube on the catalyst layer; and
coating an electroless deposition solution on the carbon nanotube coating layer.

2. The method of claim 1, wherein the base structure comprises a substrate and a first electrode formed on the substrate.

3. The method of claim 1, wherein the catalyst layer comprises a photocatalytic compound.

4. The method of claim 3, wherein the photocatalytic compound contains TiO2 and polyvinyl alcohol.

5. The method of claim 3, further comprising exposing the catalyst layer to UV light to activate the photocatalytic compound, after the forming the catalyst layer on the base structure.

6. The method of claim 1, wherein the catalyst layer comprises an electroless deposition catalyst.

7. The method of claim 6, wherein the electroless deposition catalyst comprises at least one selected from the group consisting of SnCl2 and PdCl2.

8. The method of claim 1, wherein the solution containing the powder of carbon nanotube is an aqueous solution.

9. The method of claim 1, wherein the electroless deposition solution contains nickel ions.

10. The method of claim 1, wherein the carbon nanotube field emission device is a triode carbon nanotube field emission device comprising a substrate, a first electrode formed on the substrate, an insulating layer exposing the first electrode and formed on the substrate, and a gate electrode formed on the insulating layer.

11. (canceled)

12. A method of manufacturing a carbon nanotube field emission device, comprising:
preparing a base structure comprising a substrate and a first electrode;
forming a catalyst layer containing one of a photocatalytic compound and an electroless deposition catalyst on the first electrode and activating the catalyst layer;
forming a carbon nanotube coating layer by coating an aqueous solution containing a powder of carbon nanotube on the catalyst layer; and
coating an electroless deposition solution containing metal on the carbon nanotube coating layer.

13. A method of manufacturing a triode carbon nanotube field emission device, the method comprising:
preparing a structure comprising a substrate, a first electrode formed on the substrate, an insulating layer exposing the first electrode and formed on the substrate, and a gate electrode formed on the insulating layer;
forming a catalyst layer containing one of a photocatalytic compound and an electroless deposition catalyst on the first electrode and activating the catalyst layer;
coating a solution containing a powder of carbon nanotube on the catalyst layer; and
coating an electroless deposition solution on the carbon nanotube coating layer.

14. The method of claim 13, wherein the catalyst layer contains the photocatalytic compound.

15. The method of claim 14, wherein the photocatalytic compound contains TiO2 and polyvinyl alcohol.

16. The method of claim 14, wherein the solution containing the poser of carbon nanotube is an aqueous solution.

17. The method of claim 13, wherein the catalyst layer contains the electroless deposition catalyst.

18. The method of claim 17, wherein the electroless deposition catalyst comprises at least one selected from the group consisting of SnCl₂ and PdCl₂.

19-20. (canceled)
